(19) United States
(12) Patent Application Publication
(10) Pub. No.: US 2010/0013210 A1
(43) Pub. Date: Jan. 21, 2010

(54) SECURITY DOCUMENT/CARD FOR IDENTIFICATION AND METHOD FOR PRODUCING A SECURITY DOCUMENT/CARD

(76) Inventor: Hans Wyssmann, Zurich (CH)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/515,649

(22) PCT Filed: Nov. 20, 2007
(86) PCT No.: PCT/DE07/02104

§ 371 Date: May 22, 2009

(30) Foreign Application Priority Data
Nov. 20, 2006 (DE) 10 2006 054 886.8

(51) Int. Cl. B42D 15/00; B41J 29/38

(52) U.S. Cl. 283/74; 283/85; 347/9; 347/16

(57) ABSTRACT

A security document, in particular, a card, for identification, preferably ID cards (for example, a personal identity card), comprising a card body, a security element, applied to the card body and planar information preferably in words and/or images, characterized in that the information is at least partly overlaid over or covered by the security element, wherein the security element is completely or at least partly visible.

The present invention relates, in general, to a security document or a card for identification, in particular, preferably an ID card, which can be a personal identity card or other identification cards, access authorizations etc. The card comprises a card body, a security element applied to the card body and planar information, which in turn is preferably information in words and/or images.

Furthermore, the present invention relates to a method for producing a corresponding security document or a corresponding card.

The invention basically relates to security documents of any kind or cards serving for identification purposes, in particular. For the sake of simplicity, the term “cards” is used in the following description as a synonym for a security document of any type.

Security documents or cards of the generic type are sufficiently known from practical experience. In addition to the security element used for providing protection against forgery, a card of such type comprises individualized information, which is located next to the security element in most cases. The security element can be an image, say for example, a hologram. The existence of a corresponding security element at least provides an indication of the genuineness of the card.

Such cards of the generic type disclosed in the prior art basically involve the risk of the removal or exchange of individualized information. The remaining card then still contains the security element. In principle, such a card can be forged if someone manages to replace the removed planar information with other corresponding information. The object underlying the present invention therefore is to design and develop a security document or a card for identification such that it provides a certain degree of protection against forgery. The invention makes it possible to inspect the genuineness of the card visually, i.e. photo-optically. A method for producing a corresponding card is also specified.

In accordance with the features of Claim 1, the security document or the card of the invention is characterized in that the information at least partly overlies or overlaps the security element, wherein the security element is completely or at least partly visible.

It has been found according to the invention that a certain degree of increased protection against forgery can be achieved by an at least partial overlay of the security element, that is to say, by virtue of the fact that the information in words and/or images overlies the security element. In doing so, the security element is completely or at least partly visible so that the defined extent of visibility of the security element also provides an indication of the genuineness of the card. In a manner suggested by the present invention, at least a part of the security element is destroyed if an unauthorized person removes the textual and/or pictorial information, for example, by scraping off the same. The application of other textual and/or pictorial information does not restore the security element to its original state so that its destroyed state becomes obvious. A photo-optical inspection by the human eye is possible by all means, thereby simultaneously providing a relatively high degree of protection against forgery.

It is feasible in this particular case for the information to completely overlie or overlap the security element, wherein such an overlay or overlap does not mean that the security element is no longer visible or noticeable. Quite the contrary, the information can also overlie the security element to the effect that the latter is indeed overlaid or overlapped in its entirety and yet its existence is noticeable.

The information is printed in a particularly advantageous manner. Printing the information with the aid of the inkjet printer, preferably in saturated colors, is of additional advantage. The primary colors can be applied by print heads that are independent of each other, preferably using two print heads for each color. Rapid printing and high-precision placing of the information are possible. The information is processed digitally and printed accordingly.

In a particularly advantageous manner, the information is placed on the entire surface of the card or the card body and this information can be transparent or semi-transparent, at least in certain regions. Furthermore, the information can comprise any kind of images, for example, even a passport photograph, a fingerprint etc. The card can be equipped with any biometric data.

Furthermore, the information comprises text or textual information, namely in any pattern or arrangement. This also enables considerable protection against forgery, namely in constant combination with the security element.

It is further feasible to generate the information by means of an ink having special visual effects, namely effects resulting from physical phenomena of diffraction, refraction and/or reflection of light. This also can increase the degree of protection against forgery, especially since it is extremely difficult to imitate corresponding effects. Moreover, it is possible for the effects to result from an interaction with a substrate, for example, the surface of the card body or interaction with the security element. This once more considerably increases the degree of protection against forgery.

In an advantageous manner, the information is placed with the aid of UV-curing inks. Such inks ensure a rapid curing on the card body or the surface of the security element. An exact positioning of the color pigments is ensured.

As already mentioned before, it is possible to apply or arrange any kind of security elements to or in the card body respectively. The security element can be a hologram or a kinegram by way of example. Corresponding security elements can ideally be combined with other information, namely by way at least partially overprinting the security element.

The security element can be readable digital information, which is assigned to a flat data carrier by way of example. A data carrier of such type can be joined to the card body using adhesive techniques so that the former, when applied to the card body, is regarded as planar information. A subsequent overprinting of the security element with the afore-mentioned information is possible.

In an advantageous manner, that surface of the card body that contains the security element or particularly the surface of the security element itself is treated for improved adhesion with the ink forming the information. Such a treatment can include roughening the card body or the surface of the security element, in particular in order to achieve an ink that forms a type of mechanical interlock with the surface of the card body. It is also feasible to treat or provide the surface of the card body or the surface of the security element, in particular with a chemical substance that promotes adhesion with the ink to be applied thereto. Physical effects, for example, using radiation are likewise possible. In principle, these measures aim at influencing the bond, for example, by way of adhesion. In doing so, it is essential to reduce the energy of the resulting boundary layer between the surface of the card body and the ink, especially since an adhesive bond involves minimum energy in the boundary layer.

It is also feasible for the ink to be applied to react, at least partly, with the material of the card body or the material of the security element, in particular. An intermediate layer resulting from this reaction likewise promotes the adhesion of the ink with the card body.

Protection against forgery is promoted by an additional measure, namely a measure according to which the information printed on the card body is coated with a layer of clear lacquer. In doing so, the entire surface of the card body or a part thereof can be coated with the layer of clear lacquer. The clear lacquer could react chemically, namely with the ink overlapped by the clear lacquer. Here too, a boundary layer can be formed for promoting the adhesion.

In an advantageous manner, the boundary layer is formed in part and in accordance with a predetermined pattern. It is further feasible for the clear lacquer to preferably contain optical security information that provides an additional degree of protection against forgery. This security information could in turn correlate or match with the information and/or the security element so that in the event of an unauthorized removal of the clear lacquer, it is extremely difficult to reestablish the correlation or defined match when reapplying a coat of clear lacquer.

Furthermore, it is possible for the clear lacquer to have a surface structure, optionally for shadow or relief formation. Such a surface structure can be created, for example, by means of the inkjet printer, namely to the effect that the clear lacquer is applied in thick and thin coats, thereby resulting in a relief formation. It is also feasible to apply the clear lacquer multiple times at least in certain regions using successive printing stations, particularly for creating a relief. It is thus possible to create any type of structures on the surface of the card.

The method of the invention achieves the previously mentioned object by means of the features of the independent claim 25. Thus, in accordance with the card of the invention, the information is applied in such a way to the card body that the former at least partly overlies or overlaps the security element, wherein the security element is completely or at least partly visible.

With respect to additional steps of the method of the invention, reference should be made to the corresponding passages describing the card of the invention in order to avoid repetition. Furthermore, reference should be made to the dependent claims relating to the inventive method and claiming its individual steps.

There are various possibilities of advantageously designing and developing the teaching of the present invention. For this purpose, reference should be made firstly to the claims subordinate to main claim 1 and secondly the following description of exemplary embodiments of the invention based on the drawings. Generally preferred design forms and developments of the teaching of the invention are also described below together with the explanation of preferred exemplary embodiments of the invention with reference to the drawings. In the drawings,

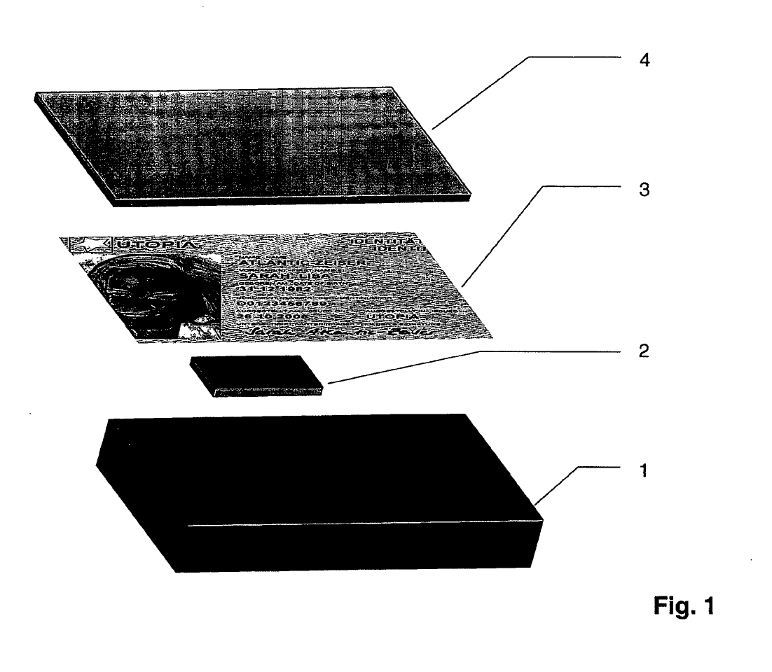

FIG. 1 is a schematic view of the basic structure of the card of the invention,

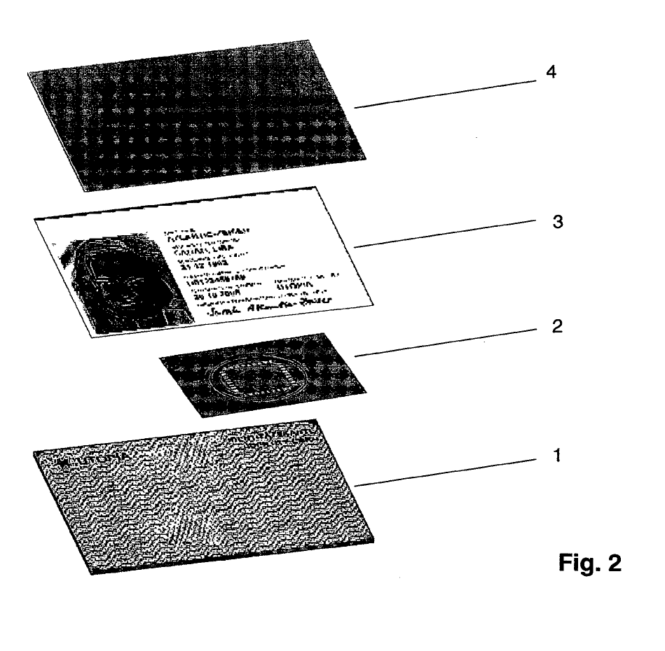

FIG. 2 is a schematic view of an additional exemplary embodiment of the card of the invention and

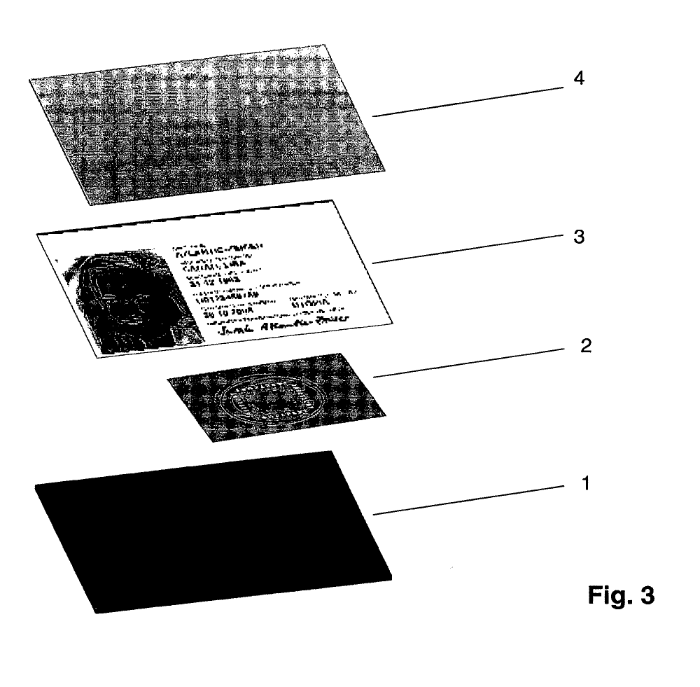

FIG. 3 is a schematic view of a third exemplary embodiment of the card of the invention.

The exemplary embodiment shown in FIG. 1 of the security document of the invention in the form of a card relates in this particular case to a personal identity card. However, it can be any card of the generic type, namely, any so-called plastic card.

The card comprises a card body 1, which in turn can be any substrate. As a rule, the card body 1 is made of a plastic.

A security element 2, which is a hologram or a kinegram by way of example, is applied to the card body 1. The security element 2 ensures a certain degree of protection against forgery.

Furthermore, the card body 1 bears planar information, which can be information in words and/or images in this particular case, as shown in the Figure.

As suggested by the present invention, the information 3 overlies or overlaps the security element 2 and in doing so, the entire card body 1. The security element 2 is nevertheless completely or at least partly visible. By virtue of the fact that the information 3 at least partly overlies the security element 2, additional protection against forgery is ensured, which goes beyond the mere presence of the security element 2. This additional protection results from the combination of the security element 2 and information 3, due to which the security element 2 is at least partly damaged or even destroyed if the information 3 is removed.

The security element 2 can be glued to the card body 1 by means of a special adhesive by way of example. It is likewise feasible to heat-seal the security element 2 to the card body 1.

The information 3 is printed on the card body 1 and thus also on the security element 2, said information being preferably printed by means of an inkjet printer.

To promote the adhesion of the inks forming the information 3 with the card body 1 or the security element 2, it is possible to implement measures promoting said adhesion. For the purpose of avoiding repetition, reference should be made in this respect to the general part of the description.

The inks forming the information 3 are UV-cured on the card body 1 so that a secure positioning of the individual pigments is ensured. The card body 1 can be overprinted multiple times for creating special colors and color relief.

Protection against forgery is increased with the aid of an additional measure, namely a clear lacquer 4, which overlaps the information 3 together with the security element 2 in its entirety. The clear lacquer 4 can likewise be applied by means of the inkjet printer, namely also by means of multiple printing. The clear lacquer 4 can likewise contain information, which is used for protection against forgery and which can correlate or correspond with both with the information 3 and the security element 2. This enables more extensive protection against forgery.

In the exemplary embodiment shown in FIG. 2 of a card of the invention, the card body 1 is printed, at least partly, and/or equipped with a relief Viewed apart, the security element 2 ensuring a certain degree of protection against forgery can likewise be printed or comprise an embossing.

If the card body 1 and/or the security element 2 is/are printed, it is essential for the two parts to be printed, preferably with ink, particularly within the scope of an industrial high-speed inkjet printing process. Colored printing is possible within the scope of digital printing, wherein different types of information can be printed.

FIG. 2 likewise suggests that the card body 1 can be a body provided with information. This information can be independent of the other information. It is also possible to supplement this information with information on the additional parts. In this particular case, the information 3 present on the card body 1 can be supplemented with information on the security element 2 to form more extensive partial or complete information.

Additional information 3 can be placed by means of inkjet printing or an appropriately designed digital printing process, namely by including the security element 2. The security element 2 and optionally the information present on the same are overprinted, at least partly, wherein the information on the card body 1 forms a type of background or basis firstly for the security element 2 and secondly for the additional information 3.

Furthermore, a clear lacquer 4 is applied, which must be regarded as an additional measure for promoting protection against forgery and as surface protection in this respect.

At this point it should be noted that the card body 1 could be equipped with any structures, relief or the like. The card body 1 itself can also be printed and any printing technique can be used for this purpose. The surface of the card body 1 could also be printed using the offset printing technology.

There is likewise additional protection against forgery by virtue of the fact that the card body 1 and the security element 2 supplement each other in terms of their information or their structure, the information 3 being placed entirely or partly thereon by means of inkjet printing. As a result, the security element 2 is completely or at least partly included in the overall printing process and thus in the appearance of the card. The clear lacquer 4 represents a type of seal, wherein, viewed apart, the clear lacquer 4 can be pigmented.

The difference between FIG. 3 and the exemplary embodiment shown in FIG. 2 is that the card body 1 is designed as a blank card body similar to the illustration in FIG. 1. Here also, the security element 2 is applied to the card body 1, wherein the printing is carried out using an inkjet printer—in single or multi-color—and at high speed. In principle, it must be ensured that there exists a high degree of adhesion between the security element 2 and the print, which once again promotes protection against forgery.

It must especially be pointed out once again that the security element 2 is included in the card using both the printing and also heat-sealing/adhesive techniques. It appears of be of particular importance that both the portions below and above the security element 2 can be provided with a print that is supplemented with the security element 2 and optionally a print present thereon. An entire body of information is formed with the inclusion of the security element 2.

With respect to additional features that cannot be inferred from the Figures, reference should be made to the general part of the description for the purpose of avoiding repetition.

Lastly, it should be noted that the exemplary embodiments discussed above merely serve to explain, by way of example, the teaching claimed without confining said teaching to said exemplary embodiments.

1.-38. (canceled)

39. A security document or a card for identification, such as an ID card, said document comprising:
a card body;
a security element applied to the card body; and
planar information,
wherein the information at least partly overlies or overlaps the security element, and wherein the security element is completely or at least partly visible.

40. The security document according to claim 39, wherein the information overlies or overlaps the security element in its entirety.

41. The security document according to claim 39, wherein the information is printed by means of an inkjet printer using saturated colors, or digitally, and wherein the information is transparent or semi-transparent, at least in certain regions, and comprises an image or text.

42. The security document according to claim 39, wherein the information is applied by means of an ink having special visual effects, with regard to at least one of diffraction, refraction, and reflection of light.

43. The security document according to claim 39, wherein the security element is designed as a hologram or kinegram.

44. The security document according to claim 39, wherein a surface of the card body that contains the security element or a surface of the security element, is treated for improved adhesion with the ink forming the information.

45. The security document according to claim 42, wherein the ink reacts, at least partly, with the material of the card body or the material of the security element.

46. The security document according to claim 39, wherein the information printed on the card body is coated with a layer of clear lacquer.

47. The security document according to claim 46, wherein the clear lacquer preferably contains optical security information, and wherein the security information correlates with the information or the security element.

48. A method for producing a security document or a card used for identification, such as an ID card, said method comprising:
providing a document that comprises a card body, a security element applied to the card body, and planar information,
wherein the information is applied to the card body in such a way that the information at least partly overlies or overlaps the security element, and wherein the security element is completely or at least partly visible.

49. The method according to claim 48, wherein the information is printed by means of an inkjet printer in saturated colors.

50. The method according to claim 48, wherein a surface of the card body that contains the security element or a surface of the security element, is treated for improved adhesion with the ink forming the information.

51. The method according to claim 49, wherein the ink reacts, at least partly, with the material of the card body or the material of the security element.

52. The method according to claim 49, wherein the information printed on the card body is coated with a layer of clear lacquer.

53. The method according to claim 52, the clear lacquer is applied by means of an inkjet printer.

54. The security document according to claim 39, wherein the planar information comprises words or images.

55. The security document according to claim 39, wherein the information is applied by means of UV-curing inks.

56. The security document according to claim 39, wherein the security element contains readable digital information.

57. The security document according to claim 44, wherein the surface of the card body or the surface of the security element is roughened or the surface of the security element is treated or provided with a substance that promotes the adhesion with the ink applied thereto.

58. The security document according to claim 46, wherein the entire surface of the card body is coated with a layer of clear lacquer or the clear lacquer forms a chemical bond with the ink in the form of a boundary layer and the boundary layer is formed in part according to a predetermined pattern.

59. The security document according to claim 46, wherein the clear lacquer has a surface structure for shadow or relief formation, and wherein the clear lacquer is applied by means of an inkjet printer.

60. The method according to claim 48, wherein the information is processed digitally and printed accordingly and wherein the inks forming the information are cured by means of ultraviolet light.

61. The method according to claim 50, wherein the surface of the card body or the surface of the security element is roughened or the surface of the card body or the surface of the security element is treated or provided with a substance that promotes the adhesion with the ink applied thereto.

62. The method according to claim 52, wherein the entire surface of the card body is coated with a layer of clear lacquer or the clear lacquer forms a chemical bond with the ink in the form of a boundary layer and the boundary layer is formed in part according to a predetermined pattern.
